(19) United States
(12) Patent Application Publication
(10) Pub. No.: US 2018/0349862 A1
(43) Pub. Date: Dec. 6, 2018

(54) Automated Estimate Systems and Methods

(71) Applicant: Roof Right Now, LLC, Austin, TX (US)

(72) Inventors: Christopher Barnard Ripley, Lichtfield, CT (US); Charles Bartol Vallely, Austin, TX (US)

(73) Assignee: Roof Right Now, LLC, Austin, TX (US)

(21) Appl. No.: 15/613,248

(22) Filed: Jun. 4, 2017

(51) Int. Cl. G06Q 10/00; G06Q 30/02; G06Q 40/08

(52) U.S. Cl. CPC G06Q 10/20; G06Q 40/08; G06Q 30/0283

(57) ABSTRACT

In some embodiments, a method may include providing, from a server system to a computing device through a network, an interface including an image of a structure corresponding to an address and including one or more user-selectable objects. The method may further include receiving, at the server system, data related to pixel positions of a plurality of shape objects arranged to represent an area to be serviced at a location corresponding to the image, and automatically determining, at the server system, real world dimensions represented by the plurality of shape objects based on a correlation between pixel positions and real world position data. The method may further include automatically generating, at the server system, a cost estimate associated with a service to be performed based in part on the received data. Additionally, the method can include sending data related to the cost estimate to the computing device.

### FIELD

The present disclosure is generally related to computing devices, and more particularly to computing devices configured to automatically estimate a cost to perform a surface repair or replacement service, such as a roof replacement, a driveway resurfacing, and so on, or to perform an installation service, such as installation of an irrigation system or installation of solar panels.

### BACKGROUND

When a structure, such as the roof of a home, is damaged, the homeowner may need to identify one or more contractors to inspect the damage and to provide an estimate of the costs to repair. Additionally, the homeowner may need to file a claim with an insurance carrier. In response to filing a claim, a claims adjuster may visit the property to determine the amount of damage and the costs required to repair the damage. Based on the results of the inspection, the property owner may receive a check equal to or less than the estimated cost of the repairs.

Similarly, when a property owner wants to have something installed (such as an irrigation system, solar panels, and so on), he or she may need to coordinate with one or more contractors to acquire estimates of the costs. However, acquiring such estimates can be a time-consuming process.

### SUMMARY

Embodiments of a computing system and associated methods may be configured to determine an image (satellite or ground-level view) of a location based on address information received from the user. The image may include a plurality of pixels, each of which may be correlated to a physical position uniquely identified by physical position data, such as latitude and longitude. The systems and methods may be configured to provide an interface including the image and including one or more user-selectable elements that can be accessed by a user to cover a portion of the image (such as the surface of the roof) within the interface to provide dimension data. The system may be configured to automatically estimate the cost of repair, replacement, or installation based at least in part on the dimension data and to automatically provide the estimate to a computing device associated with the user, to an email account associated with the user, or both. Further, the system may provide an alert including the estimate to a sales representative for follow up.

In some embodiments, a method may include providing, from a server system to a computing device through a network, an interface including an image of a location corresponding to an address and including one or more user-selectable objects accessible by a user to add and selectively position, resize, and rotate one or more shape objects on the image to circumscribe an area to which or within which a selected service is to be performed. The method may further include receiving, from the computing device at the server system, data related to the pixel position of the one or more shape objects. Further, the method may include automatically generating, at the server system, a cost estimate associated with the service based in part on the received data. Additionally, the method can include sending data related to the cost estimate to at least one of the interface and an email account associated with a user of the computing device.

In other embodiments, a computing device may include a network interface configured to communicate with a computing device through a network. The computing device may further include a processor coupled to the interface and a memory accessible to the processor. The memory may be configured to store instructions that, when executed, can cause the processor to provide an interface to the computing device including an image of a location corresponding to an address and including one or more user-selectable elements accessible by a user to place one or more shape objects to cover a portion of the image. The memory may further store instructions that, when executed, cause the processor to receive data corresponding to the pixel positions associated with the one or more shape objects and to automatically determine a cost estimate for a service to be performed based in part on the received data, and provide the repair estimate to the interface.

In still other embodiments, a computing device can include a network interface configured to communicate with one or more computing devices through a network. The computing device may further include a processor and a memory accessible to the processor. The memory may be configured to store instructions that, when executed, cause the processor to provide address information corresponding to a structure to a server system through the network and receive an interface including an image of the structure and including a user selectable element. The user-selectable element can be accessed by a user to position one or more shape objects on the image, each shape object can be repositioned by the user by dragging and dropping the shape object. Further, each shape object may include at least one of a resizing element and a rotation element accessible by the user to adjust the shape object. The user-selectable element accessible by the user to add the one or more shape objects to cover a portion of the image defining an area to be serviced. The memory may further include instructions that, when executed, cause the processor to send data related to the one or more shape objects to the server system and to receive a cost estimate corresponding to the service to be performed.

### BRIEF DESCRIPTION OF THE DRAWINGS

FIG. 1 depicts a block diagram of estimation system, in accordance with certain embodiments of the present disclosure.

FIG. 2 depicts an interface provided by the system of FIG. 1 to receive address information, in accordance with certain embodiments of the present disclosure.

FIG. 3 depicts the interface including an image showing a top view of a location including a structure corresponding to the address received in response to the interface of FIG. 2, in accordance with certain embodiments of the present disclosure.

FIG. 4 depicts the interface including the image and including a rectangular object positioned on the image, in accordance with certain embodiments of the present disclosure.

FIG. 5 depicts the interface of FIG. 4 with the rectangular object rotated to align to the orientation of the structure, in accordance with certain embodiments of the present disclosure.

FIG. 6 illustrates the interface of FIG. 5 with the rectangular object resized, in accordance with certain embodiments of the present disclosure.

FIG. 7 depicts the interface of FIG. 6 with an additional rectangular object positioned on the image and including a dropdown menu accessible by a user to alter the shape of the object, in accordance with certain embodiments of the present disclosure.

FIG. 8 depicts the interface of FIG. 7 with two overlapping rectangular objects positioned on the structure, in accordance with certain embodiments of the present disclosure.

FIG. 9 depicts the interface of FIG. 8 after submission of the object information and including user-selectable elements to determine further information about a service to be performed, in accordance with certain embodiments of the present disclosure.

FIG. 10 depicts the interface of FIG. 9 after submission of the further information and including user-selectable elements configured to determine selections related to a replacement roof surface, in accordance with certain embodiments of the present disclosure.

FIG. 11 depicts the interface of FIG. 10 after submission of the selection data and including user-selectable elements configured to receive user contact information, in accordance with certain embodiments of the present disclosure.

FIG. 12 depicts the interface of FIG. 11 after submission of the contact information and including an estimate of the cost of the roof replacement, in accordance with certain embodiments of the present disclosure.

FIG. 13 depicts a method of automatically generating a roof replacement estimate based on information determined from a user, in accordance with certain embodiments of the present disclosure.

FIG. 14 illustrates a method of automatically generating a roof replacement estimate, in accordance with certain embodiments of the present disclosure.

FIG. 15 depicts a method of automatically generating an estimate based on objects drawn onto an image, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

In accordance with various embodiments, the methods and functions described herein may be implemented as one or more software programs running on a computer processor or controller. In accordance with various embodiments, the methods and functions described herein may be implemented as one or more software programs running on a computing device, such as a tablet computer, smartphone, personal computer, server, or any other computing device. Dedicated hardware implementations including, but not limited to, application specific integrated circuits, programmable logic arrays, and other hardware devices can likewise be constructed to implement the methods and functions described herein. Further, the methods described herein may be implemented as a device, such as a computer readable storage medium or memory device, including instructions that when executed cause a processor to perform the methods.

Embodiments of systems, methods, and computing devices are described below that can be configured to automatically determine a cost of repair, replacement, or installation services at a location. Such services may include, but are not limited to, the repair of the roof of a house or building, the resurfacing of a driveway, the installation of an irrigation system, the installation of a solar panel system, other services, or any combination thereof. The system may be configured to automatically determine the cost of the service to be performed based on user interactions with a graphical user interface including images (satellite or street view) of a location. In a particular example, the system may provide an interface that can be rendered within an Internet browser application executing on a computing device associated with a user. The interface may prompt the user to enter a street address. In response to receiving the street address, the system may retrieve an image of the location from a database and may present the image in the interface with one or more user-selectable elements accessible by the user to cover or outline the shape of an area to be serviced. The user may click on the image one or more times to place objects, each of which can be resized, rotated, or otherwise adjusted to fit the shape of the area. Once the user is done, he or she may select a user-selectable element (such as a button) to submit the information to the system.

In response to receiving the information, the system may automatically determine dimensions of the area to be serviced based on a correlation between the pixel locations of the one or more objects and real world physical location data (such as latitude and longitude data). Further, the system may automatically use the dimension data to generate an estimate of the cost of the service, and may selectively communicate the estimate to the computing device associated with the user. In some embodiments, the system may also send the estimate to a sales representative to follow up with the user to finalize the transaction. In some embodiments, prior to generating the estimate or prior to communicating the estimate to the computing device associated with the user, the system may acquire contact information associated with the user, so that the sales representative can follow up. Other embodiments are also possible.

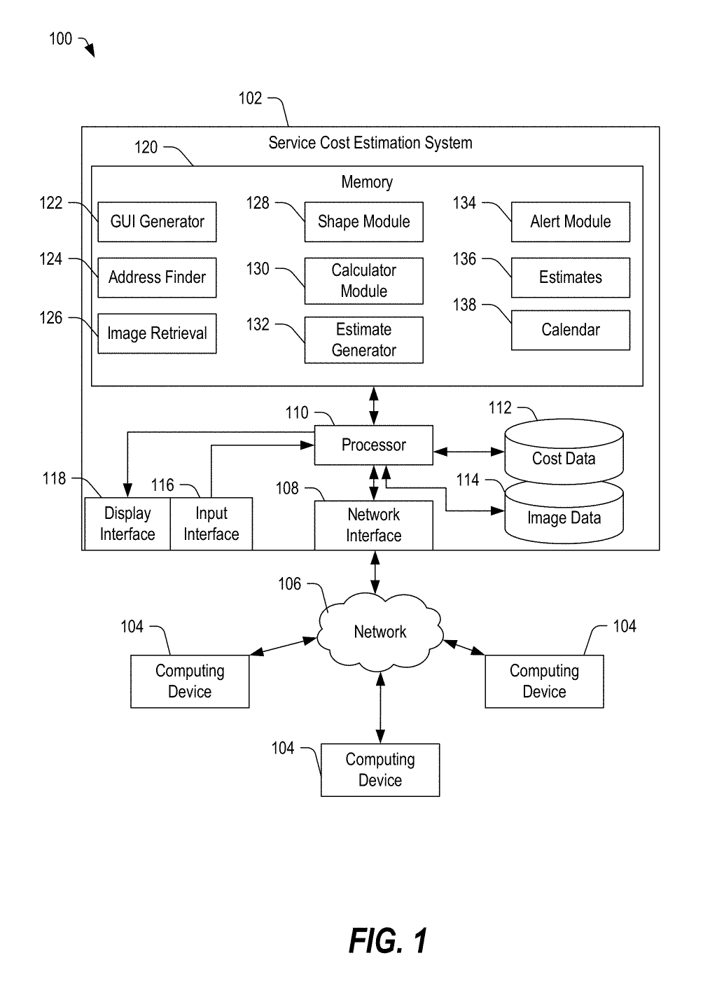

FIG. 1 depicts a block diagram of an estimation system 100, in accordance with certain embodiments of the present disclosure. The system 100 may include a service cost estimation system 102, which may be configured to communicate with one or more computing devices 104 through a network 106, such as the Internet. The one or more computing devices 104 can include tablet computers, laptop computers, smartphones, desktop computers, other computing devices, or any combination thereof, each of which may include a display and an input interface (which may be implemented as a touchscreen) and a processor coupled to the display and to the input interface. Each of the computing devices 104 may include an application that can provide an interface for displaying images and text and for receiving user inputs. In some embodiments, the application may be an Internet browser application that may interact with the system 102 in FIG. 1. In other embodiments, the application may be an estimate application that can be executed by the processor of the computing device 104.

In some embodiments, the service cost estimation system 102 may be configured to estimate repair, replacement, and installation services, such as roof repair/replacement, driveway replacement, driveway resurfacing, driveway sealing, paint services, irrigation system repair or installation, solar panel installation, other services, or any combination thereof. Further, in some embodiments, the system 102 may be configured to estimate costs of services for structures that do not yet exist. Other embodiments are also possible.

In some embodiments, the system 102 may include a network interface 108, which may be configured to send data to and to receive data from the network 106. The system 102 may also include a processor 110 coupled to the network interface. The processor 110 may also be coupled to cost data 112, which may include material costs, labor costs, waste disposal costs, and other costs associated with particular services to be rendered. The processor 110 can also be coupled to image data 114, which may include satellite images, street view images, user-provided images, other images, or any combination thereof. The processor 110 can be coupled to an input interface 116 to receive input data and to a display interface 118 configured to display data (or to provide data to a display, depending on the implementation). The processor 110 may also be coupled to a memory 120.

In some embodiments, the input interface 116 and the display interface 118 may be combined in a touchscreen interface. In other embodiments, the input interface 116 may be coupled to an input device, such as a keyboard, a keypad, a stylus, other input devices, or any combination thereof. Further, the display interface 118 may include a port configured to couple to a display device, such as a liquid crystal display (LCD).

The memory 120 may include a graphical user interface (GUI) generator 122 that, when executed, may cause the processor 110 to produce an interface that can be sent to one or more computing devices 104 through the network 106. The interface may include data, images, and one or more user-selectable elements, such as buttons, menus, tabs, clickable boxes, radio buttons, and the like. In some embodiments, the interface may be configured to display an image and to receive an input causing the interface to place one or more objects onto the image. In an example, the objects may be rectangular shaped objects that can be rotated and resized to fit a desired shape. In some embodiments, the interface may include a user-selectable option to alter the shape selection, such as to provide an elliptical or circular shape, a triangular shape, or another shape. Further, in some embodiments, the user may select the image a first time to place a first object and may select the image a second time to place a second object. The first and second objects may be independently resized and oriented. Other embodiments are also possible.

The memory 120 may further include an address finder module 124 that, when executed, may cause the processor 110 to determine an address associated with a particular user. In an example, the address finder module 124 may cause the interface to prompt the user to acquire the user's address. The memory 120 may also include an image retrieval module 126 that, when executed, may cause the processor 110 to retrieve an image associated with the determined address from the image data 114. The image may include a satellite view, a street view, or another view of a location, which may include a structure, such as a house. The memory 120 can also include a shape module 128 that, when executed, may cause the processor 110 to place a shape or object onto the image within the interface. Each shape includes one or more size adjustment elements and a rotation adjustment element, which elements may be accessed by a user to to adjust the size and orientation of a shape.

The memory 120 can also include a calculator module 130 that, when executed, may cause the processor 110 to determine a shape and size of an area to be serviced, replaced or installed based on one or more objects placed on the image. In some embodiments, the calculator module 130 may determine overlapping objects and may automatically adjust for the overlaps to calculate the area. In particular, the corners and edges of the shape objects on the image correspond to pixels within the image, and each pixel may correspond to a location in the real world. In a particular example, the image may include embedded pixel coordinates that can be mapped to longitude and latitude values, which can reference points in the world uniquely, for example, according to the World Geodetic System (WGS84) standard. In some embodiments, the world coordinate can be a floating point value measured from an origin of the map's projection to the specific location on the map independent of the zoom level of the image. In the context of a map from Google® Maps, the world coordinates can be measured from the Mercator projection's origin (which is at 180 degrees longitude and approximately 85 degrees latitude), increasing in an X-direction (east) and increasing in a Y-direction (south). While the world coordinates reflect absolute locations on a given projection, the world coordinates can be translated into pixel coordinates to determine a “pixel” offset at a selected zoom level. In the context of Google® Maps, the pixel coordinates are calculated using the following equation:

PixelCoordinate=WorldCoordinate*2^{ZoomLevel} (1)

as described at https://developers.google.com/maps/documentation/javascript/maptypes.

In certain embodiments, the calculator module 130 may cause the processor 110 to utilize the pixel coordinates to determine the exact pixel at a particular location. In particular, the calculator module 130 may cause the processor 110 to correlate the corners and edges of the shapes placed on the image within the interface to the pixel coordinates. The physical size of the shape can be determined from the pixel coordinates, allowing the outline-size of the shape to be calculated from the pixel coordinate data. Further, the calculator module 130 may utilize data received from a user to estimate a total surface area and dimensions of the portion of the structure to be estimated. In an embodiment involving a roof repair estimate, the data from the user may include a complexity parameter related to the relative complexity of the roof, a steepness parameter related to the incline of the roof, a height (single story, two story, etc.), and other data. This further information may be used by the calculator module 130 to estimate a total surface area and dimensions of the portion of the structure to be estimated.

The memory 120 may also include an estimate generator 132 that, when executed, may cause the processor 110 to utilize cost data 112 and the total surface area and dimensions determined by the calculator module 130 to estimate a cost of repair, replacement, or installations services. In some embodiments, the estimate generator 132 can use other data received from the user, such as material selectons and the like, to determine the estimated cost. In a roof replacement example, the other data can include one or more material selections (shingles and shingle quality, metal, ceramic, cedar, or other materials), colors, and so on.

The memory 120 can also include an alert module 134 that, when executed, may cause the processor 110 to communicate the estimate to the computing device 104 of the user via the interface, to an email account associated with the user, or both. In some embodiments, the alert module 134 may cause the processor 110 to communicate the estimate as well as contact information associated with the user to a sales representative for follow up. In some embodiments, the processor 110 may also store the estimates 136 in memory 120.

In some embodiments, the memory 120 may also include a calendar module 138 that, when executed, may cause the processor 110 to facilitate communications between the sales representative and the potential customer to schedule follow ups for onsite inspections or to complete the sales transaction. Further, the calendar module 138 may be used by the sales representative to schedule the service. Other embodiments are also possible.

It should be appreciated that the cost estimate system 102 may be used to calculate the costs of a service to be performed, whether the service is a repair, a replacement or a new installation. Further, the system 102 may utilize image data with embedded location data to determine dimensions of the area to be serviced, enabling automated estimates for the types of services that traditionally have required a manual inspection. In the following discussion, a roof repair estimation process is used as an example; however, it should be understood that the same process could be used to provide estimates for other services, albeit using different information.

In a particular embodiment, the system 102 may be configured to receive information related to a particular address and to automatically estimate the cost of repair or replacement for a portion of the structure based on the received information. In an embodiment involving a roof repair, the received information may include the address, the size, shape, and orientation of one or more user-adjustable objects overlaid on a satellite image of the structure (such as a Google® maps image), and other information, such as a number of stories of the structure, the complexity of the roof, the steepness of the roof, the type and color of replacement roof materials, other information, or any combination thereof. In the context of other types of service, different information may be collected (such as a driveway resurfacing color, or a brand of device or system for installation, and so on).

In some embodiments, in conjunction with the automatically determined dimensions, the system 102 may utilize material costs, labor costs, steepness, complexity, size, geographic location, disposal costs, time-of-year, demand, and other information to estimate the replacement costs. In an example, labor costs may be higher in northern states during the winter months than during other months of the year. Further, the disposal costs in some municipalities may be greater than in others. As a result, the cost estimate may vary based on the location, the time of year, the size area to be serviced, the user-selected replacement material, and so on. The system 102 may be configured to automatically provide a customized estimate of repairs based on the information received from the user via the interface.

It should be appreciated that the automated estimate generation capabilities provided by the system described herein provide a number of advantages and improvements over conventional systems. One particular advantage is that the system 102 can generate an accurate estimate, even when portions of a structure are occluded by the environment, such as overhanging trees. Other advantages can include that the system 102 can generate an accurate estimate in real-time or near real-time and without the involvement of a human operator. Further, an additional advantage can be realized in that the automated calculations can be more accurately determined from the pixel coordinate than from manual measurements. Still another advantage is that the system 102 can calculate an estimate for a theoretical structure that does not yet exist, simply by placing objects on a portion of the image representing an undeveloped area to define dimensions of the area to be serviced. Other advantages are also possible.

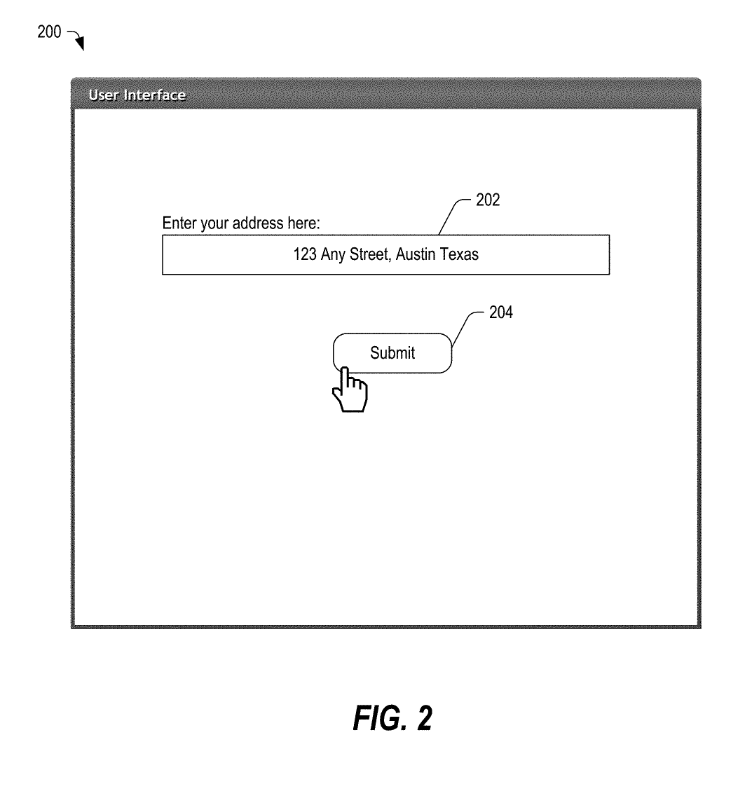

In the following discussion of FIGS. 2-12, a series of interfaces are shown to represent a user experience at the computing device 104 when interacting with the system 102. In this particular example, the user may interact with the system 102 to acquire an estimate for a roof repair service.

FIG. 2 depicts an interface 200 provided by the system of FIG. 1 to receive address information, in accordance with certain embodiments of the present disclosure. In the illustrated example, the interface 200 may include user-selectable elements, including a text field 202 configured to receive address information and a button 204 that may be selected to submit the address information to the system 102 in FIG. 1. In some embodiments, other user-selectable elements may be used to acquire the address information. Such user-selectable elements may include pull-down menus, checkboxes, radio buttons, and so on. For example, the state information may be collected using pull-down menus or radio buttons that allow for only one selection. In some embodiments, instead of a mailing address, the interface 200 may be configured to receive longitude and latitude information or other information that can unique specify the area in which an estimate may be performed. Other embodiments are also possible.

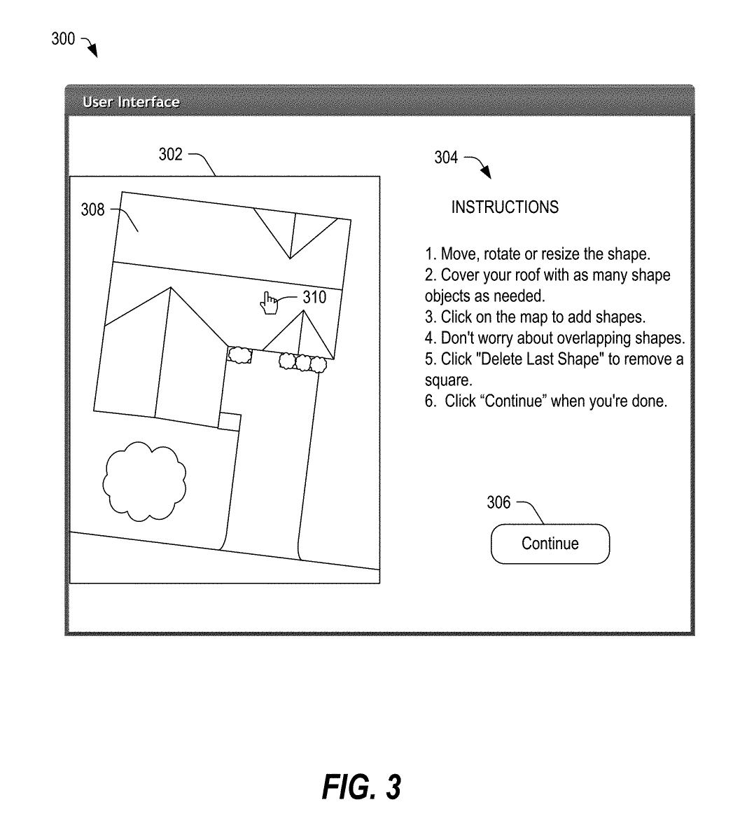

In some embodiments, in response to receiving the address information, the system 102 may retrieve image data associated with the address. In a particular example, the system 102 may retrieve image data that includes satellite image data of the location based on the address information, which satellite image data may retrieved from Google® maps or from another source. As mentioned above, the satellite image data may further include pixel coordinate data that can be used to correlate a selected pixel within the image data with a unique physical location. The image data may then be included in the interface provided to the computing device associated with the user. One possible example of the interface including the image data is described below with respect to FIG. 3.

FIG. 3 depicts the interface 300 including an image 302 showing a top view of a structure 308 corresponding to the address received in response to the interface of FIG. 2, in accordance with certain embodiments of the present disclosure. It should be understood that the interface 300 may be rendered within an Internet browser application executing on a computing device 104, such as a tablet computer, a laptop computer, a smartphone, or another computing device. The interface 300 may further include instructions 304 that describe how the user may interact with the image 302. As discussed above, the image 302 may include pixel coordinate data that can correlate pixels within the image to unique location data. It should be appreciated that the pixel coordinate data corresponds to each pixel within the image 302 including driveway area, street area, the yard, and the structure at the specified location.

The interface 300 further includes a user-selectable button 306 that can be selected by a user to continue the estimation process. In some embodiments, the button 306 may be “grayed out” or otherwise inaccessible to the user until the user interacts with the image or provides requested data. Within the image 302, a pointing hand 310 is shown that corresponds to a position of a pointer, such as a pointer associated with a mouse or stylus. In certain embodiments, the user may position the pointing hand 310 over the image and may click the mouse or otherwise select the image, which may cause the interface 300 to place an object on the image. In some embodiments, the object may be a rectangle. In some embodiments, the object may be a default shape and the user may right-click on the shape to select a different shape object, such as to change the object from a rectangle to a circle. Other embodiments are also possible.

In the illustrated example, according to the instructions 304, the user may add a shape object and then move, rotate, or resize the shape object. The interface 300 may present the shape object as an overlay on the image 302. In some embodiments, the user may add one or more shape objects to the image 302, for example, to cover the structure 308 (such as the roof) with as many shape objects as needed. Alternatively, the user may add shape objects to specify a shape and area that is not yet developed, or may apply the objects to outline an area to be developed or improved. For example, the user may apply a shape to outline an area where a shed is to be constructed or where stand-alone solar panel assemblies may be installed. Alternatively, the user may apply one or more shapes to an area, such as the driveway. Other embodiments are also possible. The user may add additional shape objects onto the map by positioning the pointer and clicking. Once a shape object is added, a button may appear that will allow the user to delete the shape object. The instructions 304 indicate that the user should not worry about overlapping shapes. Once the structure is covered with shape objects, the user may select the “Continue” button 306 to proceed with the estimate process.

It should be appreciated that, while in the following discussion a roof estimation process is described, the system, interfaces, and methods described herein can be used in a variety of contexts to estimate a bill of materials, labor and disposal costs, and so on based on dimension information determined from the pixel coordinate data. For example, the system could be used to estimate costs and a table of energy generation values for a solar installation. Alternatively, the system could be used to estimate a cost of replacement or resurfacing of the driveway. In another embodiment, the system could be used to estimate the cost of a storage shed, and so on, or to estimate the cost to install a sidewalk or an irrigation system. Other embodiments are also possible.

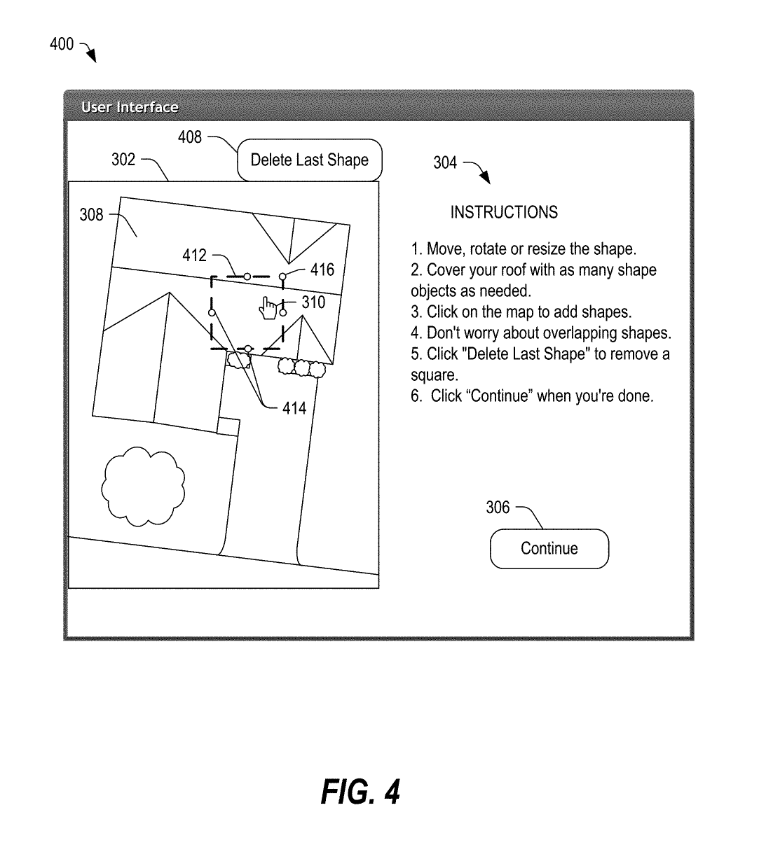

FIG. 4 depicts the interface 400 including the image 302 and including a rectangular object 412 positioned on the image 302, in accordance with certain embodiments of the present disclosure. As mentioned above, the user may position the pointer 310 on the image 302 and may click, which may cause the interface 400 to place the rectangular object 412 on the image 302. In the illustrated example, the rectangular object 412 may include resize elements 414 that may be used to resize the rectangular object 412 using the pointer 310. The rectangular object 412 may further include a rotation element 416 that may be selected using the pointer 310 to rotate the object 412. Other embodiments are also possible.

In this example, the object 412 is applied to the roof of the structure 308, but the system is not so limited. In particular, the object 412 may be applied at any position within the image 302. The corners and edges of the object 402 may correspond to pixel coordinates within the image 302, and may be used to determine the size of the area specified by the user.

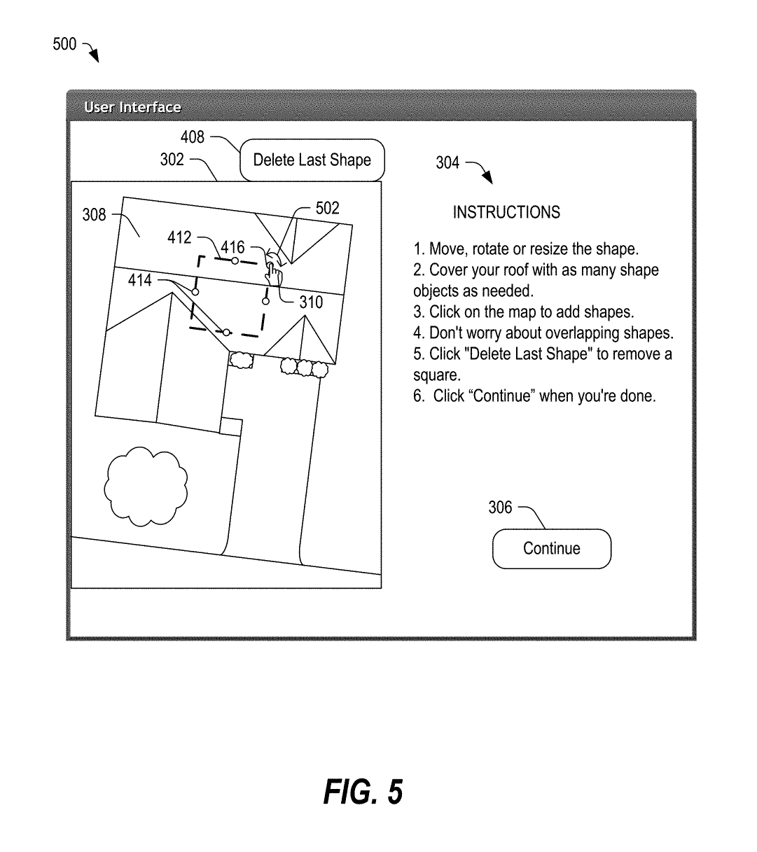

FIG. 5 depicts an embodiment 500 of the interface 400 of FIG. 4 with the rectangular object 412 rotated to align to the orientation of the structure 308, in accordance with certain embodiments of the present disclosure. The user may have used the pointer 310 to select the rotation element 416 to rotate the object 412 as indicated by the arrow 502. Further, the user may utilize the pointer 310 to resize the object 412 using the resize elements 414.

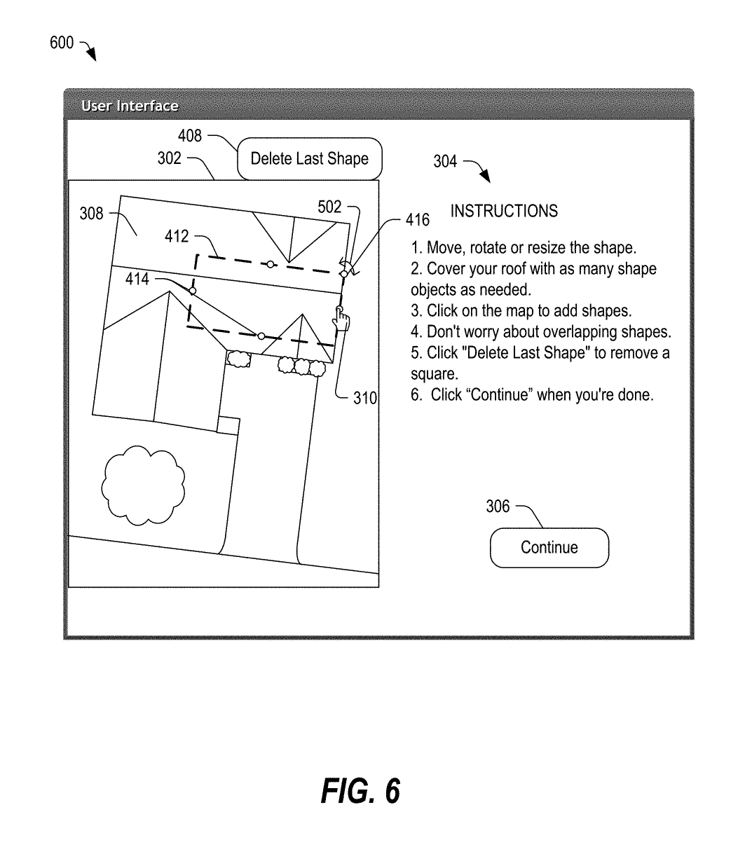

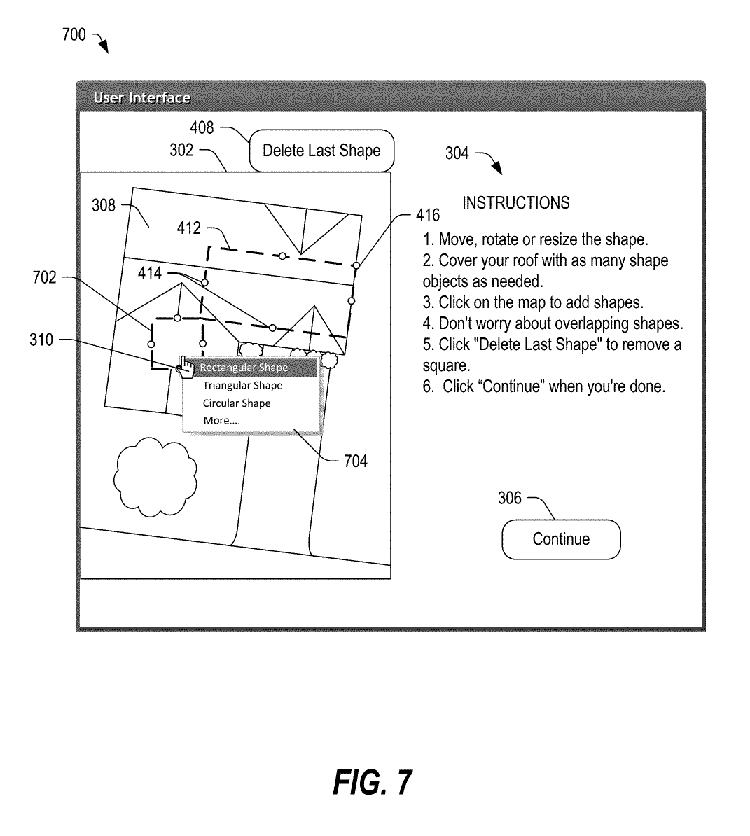

FIG. 6 illustrates an embodiment 600 the interface of FIG. 5 with the rectangular object 412 resized, in accordance with certain embodiments of the present disclosure. In the illustrated example, the user may utilize the pointer 310 to grab one of the resize elements 414 to expand the object 412. As the instructions indicate, the user may add additional shapes to the image 302, as depicted in FIG. 7.

FIG. 7 depicts an embodiment 700 of the interface of FIG. 6 with an additional rectangular object 702 positioned on the image 302 and including a dropdown menu accessible by a user to alter the shape of the object, in accordance with certain embodiments of the present disclosure. In the illustrated example, the user may utilize the pointer 310 to click on the image 302, and the interface 700 may add another rectangular object 702 on the image 302. In this example, the object 702 can be resized, rotated, repositioned, or any combination thereof.

In the illustrated example, the user may right-click on the object 702 to access a pull-down menu 704 that can be used to select a shape, for example, other than a default rectangular shape. For example, the user may select a triangular shape, a circular shape, or another shape, which can then be repositioned, resized, rotated, or any combination thereof. In an example involving an irregular-shaped structure, such shapes may be used to confirm the objects to the shape of the structure. Other embodiments are also possible.

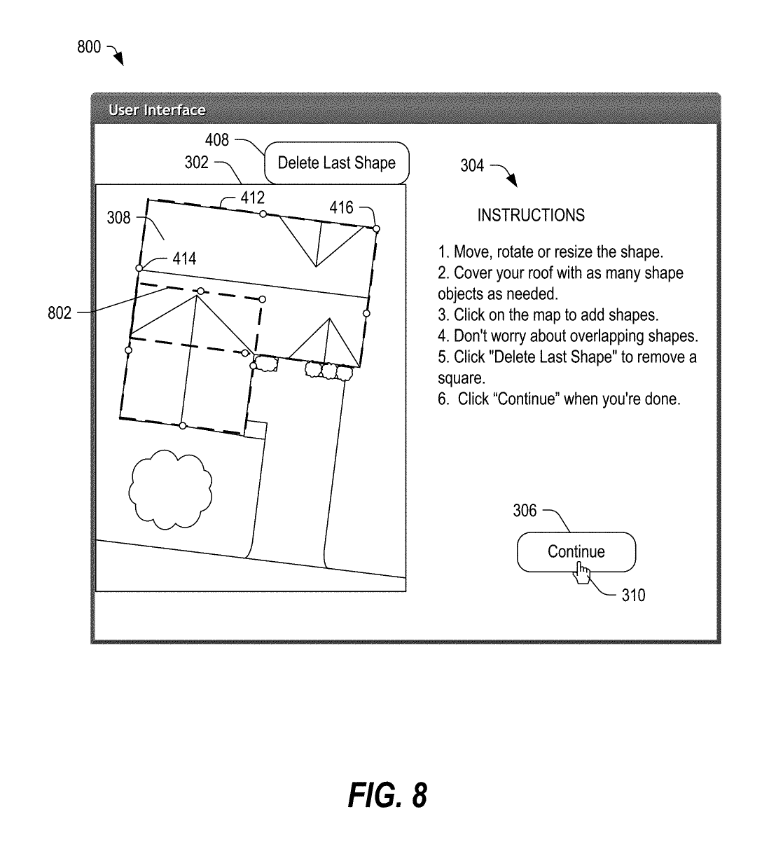

FIG. 8 depicts an embodiment 800 of the interface of FIG. 7 with two overlapping rectangular objects 412 and 802 positioned over a roof of the structure 308, in accordance with certain embodiments of the present disclosure. The user may then position the pointer 310 over the “Continue” button 306 and may select the “Continue” button 306.

In the illustrated example, the shape objects 412 and 802 are applied to the roof of the structure 308 and that a portion of the objects 412 and 802 overlap. The computing system that performs the area calculations may be configured to combine the objects to remove duplicate areas due to such overlaps.

Again, it should be appreciated that the discussion is directed to generation of estimates for roof replacement or roof resurfacing; however, the system can be configured to generate estimates for other installation or repair services as well. For example, the system may be utilized for irrigation system installations, by applying objects to the yard to indicate water coverage areas, and the system can generate an estimate for sprinkler system installation to achieve the selected coverage areas. In another example, the system can be utilized for solar panel installation estimates by placing objects within the image to represent the solar panel assemblies. In still another example, the system can be used to estimate the cost for a roof or for other aspects of a structure that hasn't been built yet, such as a storage shed in the back yard. Other embodiments are also possible.

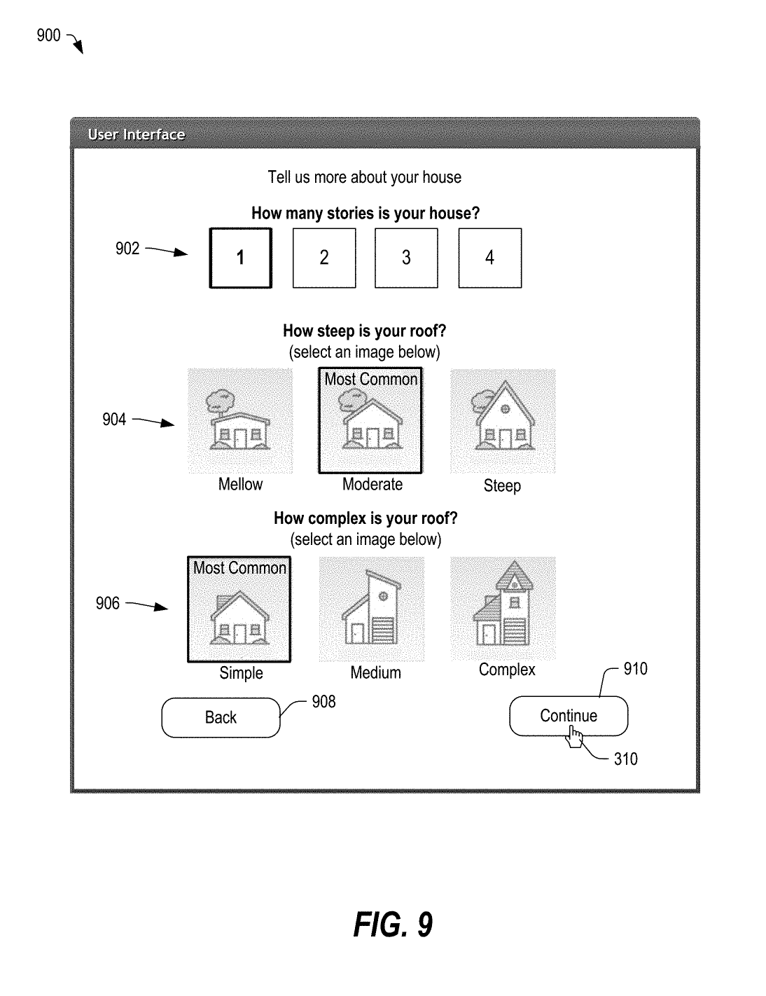

FIG. 9 depicts an embodiment 900 of the interface of FIG. 8 after submission of the object information and including user-selectable elements configured to determine further information about the structure, in accordance with certain embodiments of the present disclosure. The interface 900 includes a plurality of user-selectable elements accessible by a user to provide further information about the structure. In this example, the interface 900 includes a first set of user-selectable elements 902 that can be accessed by a user to specify the number of stories associated with the structure (e.g., one, two, three, or four). In the illustrated example, the user-selectable elements 902 are depicted as selectable buttons, with the “One” option selected. In other embodiments, the user-selectable elements 902 may be implemented as radio buttons, a pull-down menu, or another input element.

The interface 900 may further include user-selectable elements 904 that can be accessed by a user to specify the steepness of the roof, such as “Mellow”, “Moderate”, or “Steep”. In the illustrated example, the user-selectable elements 904 are depicted as selectable buttons, with the “Moderate” option selected. In other embodiments, the user-selectable elements 904 may be implemented as radio buttons, a pull-down menu, or another input element. Other embodiments are also possible.

The interface 900 may also include user-selectable elements 906 that can be accessed by a user to specify the complexity of the roof, such as “Simple”, “Medium”, or “Complex”. In the illustrated example, the user-selectable elements 906 are depicted as selectable buttons, with the “Simple” option selected. In other embodiments, the user-selectable elements 906 may be implemented as radio buttons, a pull-down menu, or another input element. Other embodiments are also possible.

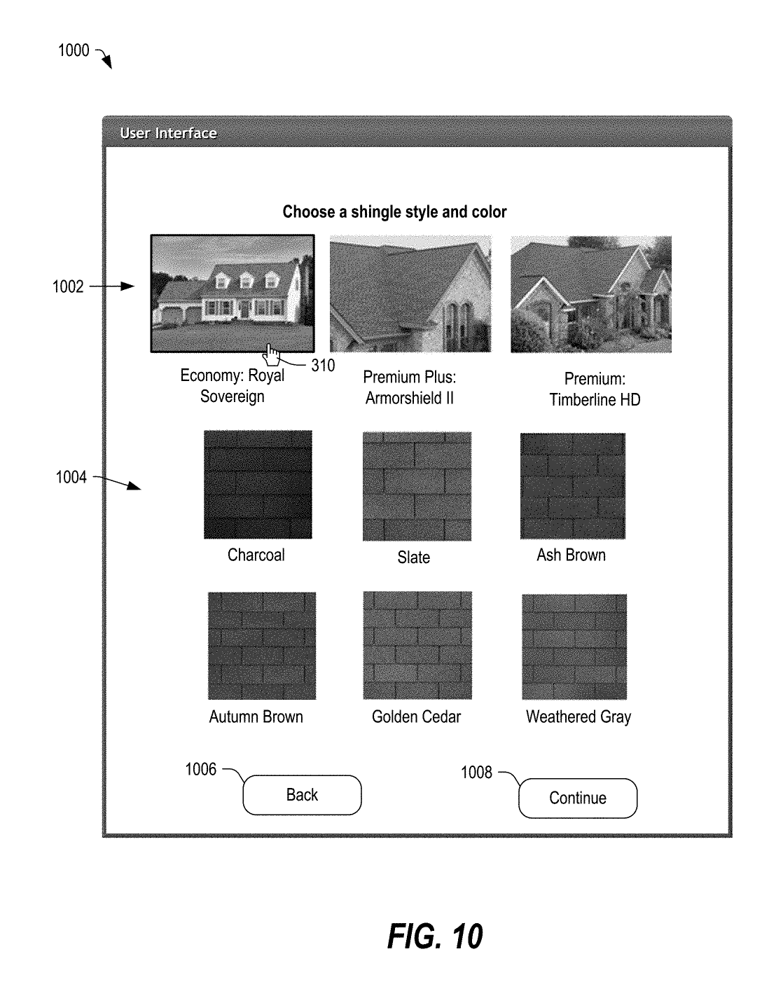

The interface 900 further includes a “Back” button 908 that may be accessed by the user to return to the interface 800 of FIG. 8. The interface 900 may further include a “Continue” button 910 that may be accessed by the user to advance to the interface 1000 in FIG. 10.

FIG. 10 depicts an embodiment 1000 of the interface of FIG. 9 after submission of the further information and including user-selectable elements configured to determine selections related to a replacement roof surface, in accordance with certain embodiments of the present disclosure. In the illustrated example, the interface 1000 provides a plurality of user-selectable elements 1002 accessible by a user to choose a shingle style from a plurality of shingle styles including an “Economy: Royal Sovereign” style; a “Premium Plus: Armorshield II” style; and a “Premium: Timberline HD” style. Other styles are also possible. In this example, the “Economy: Royal Sovereign” style is selected.

Further, the interface 1000 includes user-selectable elements 1004 accessible by the user to choose a shingle color. In the illustrated example, the color options under the “Economy: Royal Sovereign” style include a Charcoal option, a Slate option, an Ash Brown option, an Autumn Brown option, a Golden Cedar option, and a Weathered Gray option. Other color options may be available under different styles. Further, it should be appreciated that the color options may change over time and that additional options may be available, depending on a variety of factors.

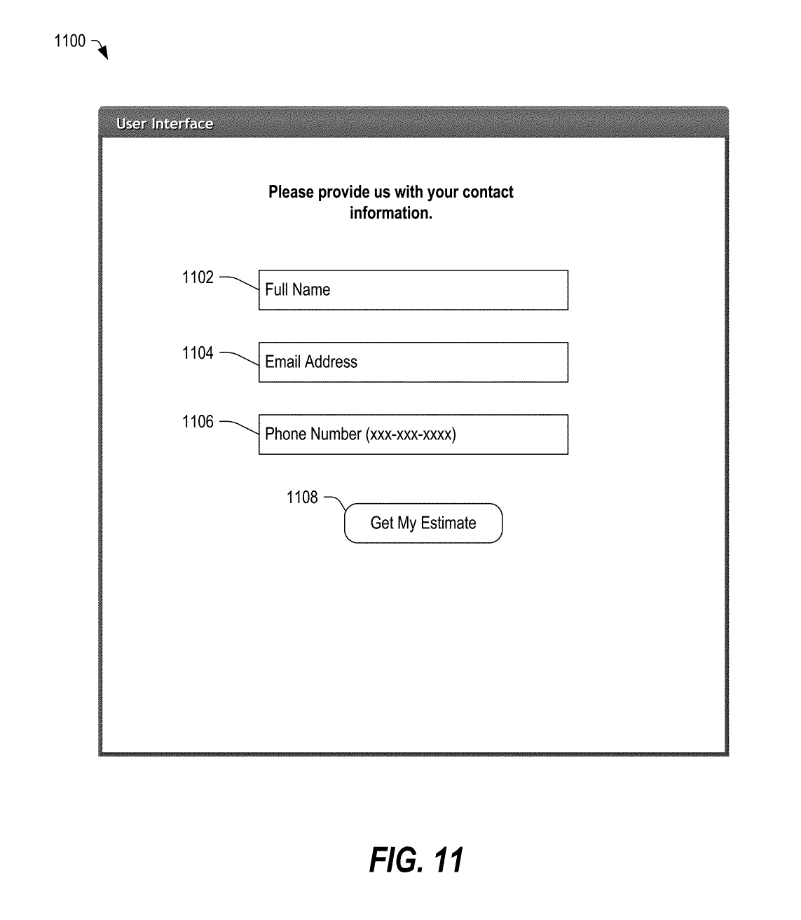

The interface 1000 further includes a “Back” button 1006 that can be accessed by the user to return to the interface 900 of FIG. 9. Additionally, the interface 1000 can include a “Continue” button 1008 that can be accessed by a user to advance to the interface 1100 of FIG. 11.

FIG. 11 depicts an embodiment 1100 of the interface of FIG. 10 after submission of the selection data and including user-selectable elements configured to receive user contact information, in accordance with certain embodiments of the present disclosure. The interface 1100 may include a first text field 1102 to receive the potential customer's name, a text field 1104 configured to receive the potential customer's email address, and a text field 1106 configured to receive the potential customer's phone number. Further, the interface 1100 may include a user-selectable button 1108 accessible by the user to receive the estimate for the project.

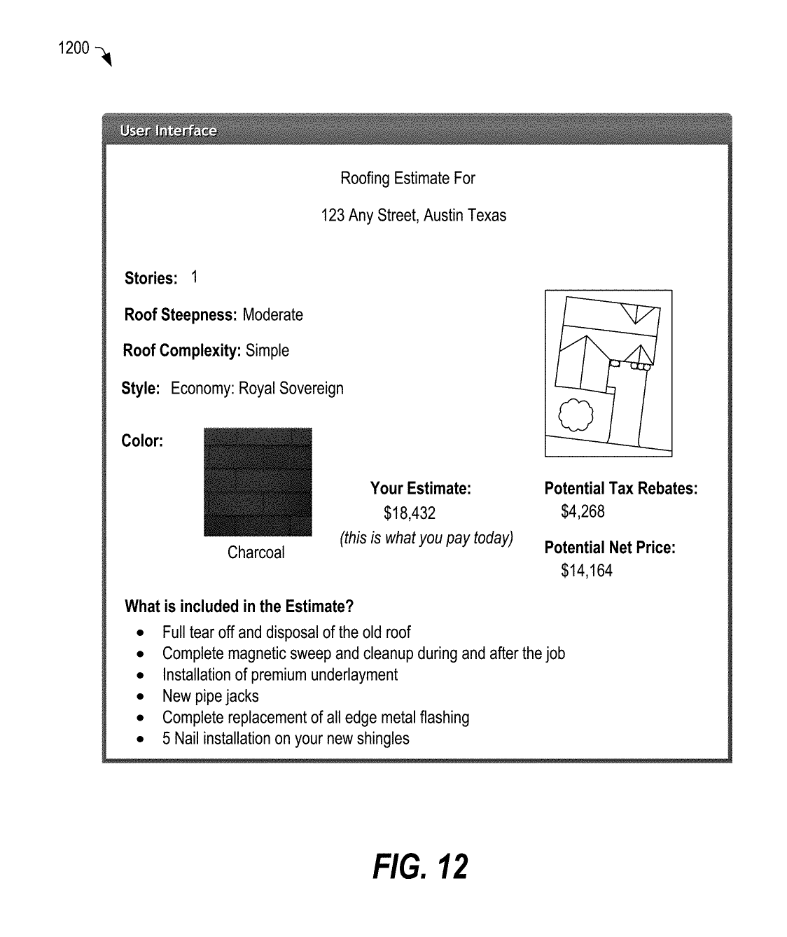

FIG. 12 depicts an embodiment 1200 of the interface of FIG. 11 after submission of the contact information and including an estimate of the cost of the roof replacement, in accordance with certain embodiments of the present disclosure. In the illustrated example, the interface 1200 may include an estimate of the cost of the project, including tax rebates and the like. Further, the estimate may show the various options selected for the particular address as well as the various services included in the estimate.

In some embodiments, in addition to presenting the estimate within the interface, the system 102 may email the estimate to the potential customer and send data related to the estimate to a sales representative (via email, text, or other communication path). Further the system 102 may store the estimate in memory 120. Other embodiments are also possible.

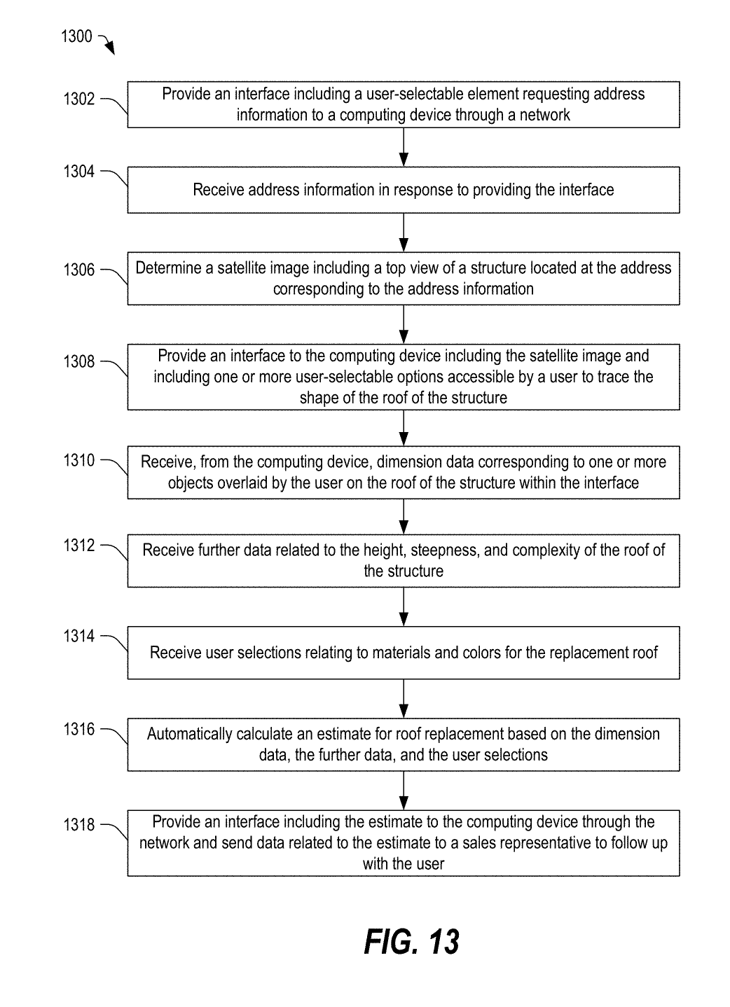

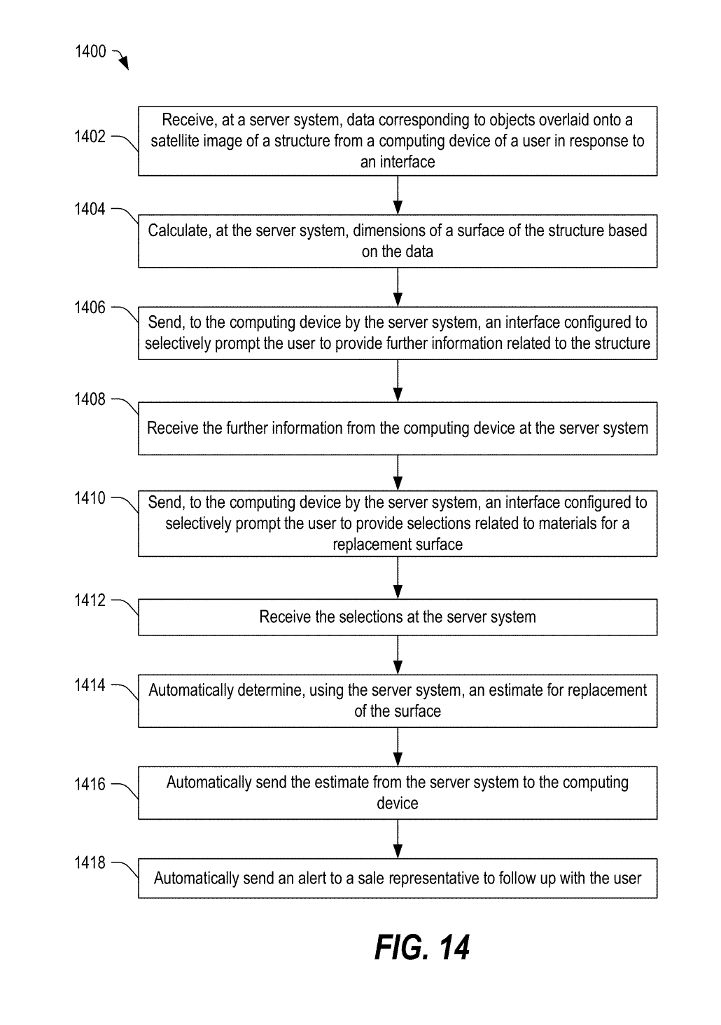

In the following discussion of FIGS. 13 and 14, methods of estimating a cost of a roof resurfacing service are disclosed. It should be appreciated that similar methods may be used to determine a cost estimate for a different service to be performed.

FIG. 13 depicts a method 1300 of automatically generating a roof replacement estimate based on information determined from a user, in accordance with certain embodiments of the present disclosure. At 1302, the method 1300 can include providing an interface including a user-selectable element requesting address information to a computing device through a network. In an example, the interface may be an embodiment of the interfaces of FIGS. 2-12. Further, in some embodiments, the interface may be presented as a web page that can be rendered in an Internet browser application executing on the computing device associated with the user.

At 1304, the method 1300 can include receiving address information in response to providing the interface. The address information may be provided by the user via the interface and may be submitted by the user by selecting a “Submit” button, a “Continue” button, or another user-selectable element.

At 1306, the method 1300 can include determining a satellite image including a top view of a structure located at the address corresponding to the address information. In some embodiments, the image data may include street view data, images supplied by the user, or image data from one or more data sources. Further, the satellite image may include pixel coordinate data that can be uniquely mapped to a location in the physical world.

At 1308, the method 1300 can include providing an interface to the computing device including the satellite image and including one or more user-selectable options accessible by a user to trace the shape of the roof of the structure. As depicted in FIGS. 5 through 8, for example, the user may position a pointer 310 on the image 302 and click to cause the interface to present a shape on the image, which can be rotated, resized, repositioned, or any combination thereof In some embodiments, the satellite image and the one or more user-selectable options may be provided within the interface as a web page that can be rendered by an Internet browser application.

At 1310, the method 1300 can include receiving, from the computing device, dimension data corresponding to one or more objects overlaid by the user on the roof of the structure within the interface. In a particular embodiment, the dimension data may include the pixel coordinate data corresponding to the corners of the shape objects that were placed on the image. In some embodiments, the system 102 may calculate the dimensions of a surface of the structure based on the pixel coordinates of the one or more objects.

At 1312, the method 1300 can include receiving further data related to the height, steepness, and complexity of the roof of the structure. In some embodiments, the system may utilize the interface to prompt the user to provide such information, as depicted in and described with respect to FIG. 9.

At 1314, the method 1300 may include receiving user selections related to materials and colors for the replacement roof. In some embodiments, the system may utilize the interface to prompt the user to provide such information, as depicted in and described with respect to FIG. 10.

At 1316, the method 1300 may include automatically calculating an estimate for roof replacement based on the dimension data, the further data, and the user selections. In some embodiments, the method 1300 may include determining overlaps with respect to the one or more objects overlaid on the image and adjusting the calculations to correct for such overlaps. In a particular example, the

At 1318, the method 1300 may include providing an interface including the estimate to the computing device through the network and sending data related to the estimate to a sales representative to follow up with the user. In some embodiments, the sales representative may call or otherwise reach out to the prospective client to answer any questions and to attempt to close the sale. Other embodiments are also possible.

In some embodiments, some of the blocks may be combined and others may be omitted without departing from the scope of the disclosure. In an example, blocks 310, 312, and 314 may be combined. Other embodiments are also possible.

FIG. 14 illustrates a method 1400 of automatically generating a roof replacement estimate, in accordance with certain embodiments of the present disclosure. At 1402, the method 1400 can include receiving, at a server system, data related to objects overlaid onto a satellite image of a structure from a computing device of a user in response to an interface. In some embodiments, the data may include pixel coordinates corresponding to the objects overlaid on the image. Further, in some embodiments, the objects may be overlaid onto the image as depicted and described with respect to FIGS. 4-8.

At 1404, the method 1400 can include calculating, at the server system, dimensions of a surface of the structure based on the data. The surface may be a roof, for example.

At 1406, the method 1400 may include sending, to the computing device by the server system, an interface configured to selectively prompt the user to provide further information related to the structure. The further information may include the height, steepness, and complexity of the surface.

At 1408, the method 1400 can include receiving the further information from the computing device at the server system. At 1410, the method 1400 can include sending, to the computing device by the server system, an interface configured to selectively prompt the user to provide selections related to materials for a replacement surface. The selections may include the type of materials as well as the color.

At 1412, the method 1400 can include receiving the selections at the server system from the computing device. At 1414, the method 1400 can include automatically determining, using the server system, an estimate for replacement of the surface. At 1416, the method 1400 can include automatically sending the estimate from the server system to the computing device. Further, in some embodiments, the method 1400 may include automatically sending an alert to a sales representative to follow up with the user.

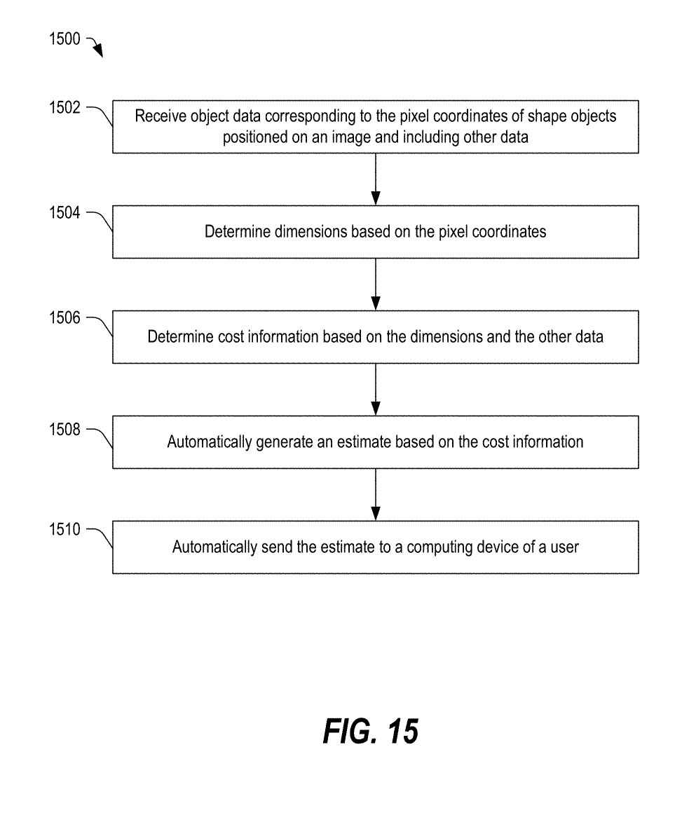

While the above-discussion has been focused largely on roof repair/replacement services, it is also possible to use the interface to determine costs and to automatically generate estimates for other types of services where the real-world dimensions are used as part of the cost calculations. In the example below, a method of generating an estimate is described that can be configured to fit a plurality of different services. One possible example is described below with respect to FIG. 15.

FIG. 15 depicts a method 1500 of automatically generating an estimate based on objects drawn onto an image, in accordance with certain embodiments of the present disclosure. At 1502, the method 1500 may include receiving object data corresponding to the pixel coordinates of shape objects positioned on an image and including other data. The pixel coordinates may include the x-y position of the object relative to the image, which may itself be correlated to latitude and longitude data in the real world.

At 1504, the method 1500 may include determining dimensions based on the pixel coordinates. The dimensions may be associated with the outline of an object translated into the real world, as well as incline, complexity, and other information determined from the other data.

At 1506, the method 1500 can include determining cost information based on the dimensions and the other data. The cost information may depend on what type of service is being performed, labor costs, the elevation, the complexity, the area, and other data. In the context of a solar panel installation, the cost may include both the labor costs and the cost for materials. In the context of a driveway resurfacing, the costs may include labor costs and material costs for the designated area. For a roof, the cost may include permit acquisition, waste capture and disposal, material costs, and labor. In other contexts, such as irrigation system installation, exterior painting, and so on, the cost data may also include predictable expenses, including the cost to dig in order to install the sprinkler heads and the plumbing, and so on.

At 1508, the method 1500 can include automatically generating an estimate based on the cost information. In addition to cost, the estimate may include an explanation of material selections as well as the services to be performed. Other embodiments are also possible.

At 1510, the method 1500 can include automatically sending the estimate to a computing device of a user. In an example, the estimate may be presented within an Internet browser interface, as an attachment to an email, as a text message, or any combination thereof.

In some embodiments, the method 1500 may include estimating a cost of repair, construction, or installation of a product for a given area specified by the user. In the context of irrigation, for example, the user may place a plurality of shape objects to overlap the irrigation area (e.g., circles, arcs, or other shapes representing the spray distribution of sprinkler heads to cover a designated area). The system may then determine the dimensions (from a correlation between the pixels associated with the shape objects and real world positions) and calculate the materials and labor costs to complete the installation. Similarly, for a roof, the system may receive data related to the shape objects placed on an image as well as data related to the complexity and height of the roof and the selected replacement materials in order to determine the cost.

In the above-discussion and examples, the top view of the location has been used for the placement of objects; however, in other embodiments different views may be used to determine the dimensions. In an example, a combination of street views and satellite views of a structure may be used to determine the dimensions of a structure for estimating a cost of painting the structure. Other embodiments are also possible.

While the embodiments described above with respect to FIGS. 1-15 describe a server system that can determine the estimate, it is also possible to implement the system as an application that can execute on a portable computing device, such as a tablet computer or smart phone that can be carried to the site by a sales representative. In some embodiments, the cost data and the image data may be accessed from a remote database via the Internet, but the other functions, including the calculation and automatic estimate generation may be performed by the portable device, enabling a sales representative to provide real-time estimates.

In certain embodiments, the system is configured to automatically generate estimates solely based on user-input data, pre-determined material and labor cost information, and publicly available image data. In this example, the user-input data may include one or more shape objects that can be positioned, rotated, and resized to overlay the image data. In some embodiments, the objects may be rectangular shapes that can be inserted and adjusted within the interface rendered within the Internet browser (or within the application) executing on the user's computing device. The pixel position of the corners or edges of the objects may be correlated to pixel coordinates within the image, which pixel coordinates may in turn by correlated to latitude and longitude data, providing a real-world mapping of pixel data to unique location data, which can be used to determine the size of the object applied to the image (translated to real world measurements).

While the above-examples are directed to providing an automated estimation system for roof replacement, it should be appreciated that the system may also be configured to generate such estimates for other types of construction, repair, or replacement services. For example, the automated estimation system can be used to estimate driveway or roadway resurfacing, painting, or other services. The costs of labor and materials will vary depending on the service being estimated. Other embodiments are also possible.

The processes, machines, and manufactures (and improvements thereof) described herein are particularly useful improvements for computers providing automated cost estimation of structural repairs, such as roof replacement, roof repair, driveway surfacing, and so on. Further, the embodiments and examples herein provide improvements in the technology of cost estimation systems that can determine cost estimates based on images, such as satellite images, street-view images, and the like. In addition, embodiments and examples herein provide improvements to the functioning of a computer by providing an interface with user-adjustable elements that can be accessed by a user to outline a shape of a structure to be repaired, and the computer may be configured to automatically estimate a cost of repair of the structure (without a human operator) based on the outline of the shape and other information, which may be supplied by the user. The system creates a specific purpose computer by adding such technology. Thus, the improvements herein provide for technical advantages, such as providing a system in which a user's interaction with a computer system and complex estimates can be determined automatically. For example, the systems and processes described herein can be particularly useful to any systems in which a user may want to have repair or replacement services performed on a structure, such as a home, a garage, a building, and so on. Further, the improvements herein provide additional technical advantages, such as providing a system in which the estimated costs of the repair or replacement services may be determined automatically. While technical fields, descriptions, improvements, and advantages are discussed herein, these are not exhaustive and the embodiments and examples provided herein can apply to other technical fields, can provide further technical advantages, can provide for improvements to other technologies, and can provide other benefits to technology. Further, each of the embodiments and examples may include any one or more improvements, benefits and advantages presented herein.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, in the flow diagrams presented herein, in certain embodiments, blocks may be removed or combined without departing from the scope of the disclosure. Further, structural and functional elements within the diagram may be combined, in certain embodiments, without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A method comprising:
providing, from a server system to a computing device through a network, an interface including an image corresponding to an address and including one or more user-selectable objects;
receiving, from the computing device at the server system, data related to pixel positions of a plurality of shape objects arranged to cover a portion of the image to represent an area to be serviced at a location corresponding to the image;
automatically determine, at the server system, real world dimensions represented by the plurality of shape objects based on a correlation between pixels of the image and real world position data;
automatically generating, at the server system, a cost estimate associated with a service to be performed based in part on the real world dimensions; and
sending data related to the cost estimate to the computing device.

2. The method of claim 1, further comprising:
receiving, from the computing device at the server system, the address; and
automatically retrieving, by the server system, the image of the structure from a database based on the address.

3. The method of claim 2, wherein the image comprises a satellite image of the location correlated to the address data.

4. The method of claim 2, wherein the image comprises a street view of the location correlated to the address data.

5. The method of claim 1, wherein automatically generating the cost estimate includes:
determining pixel coordinates for each of the plurality of shape objects, the pixel coordinates correlated to real world location data; and
determine the real world dimensions based on the pixel coordinates of the plurality of shape objects.

6. The method of claim 5, further comprising:
retrieving, from a cost database by the server system, material cost and labor cost based on material selections received from the computing device; and
generating the estimate based on the dimensions and retrieved costs including the material cost and the labor cost.

7. A computing device comprising:
a network interface configured to communicate with a computing device through a network;
a processor coupled to the interface; and
a memory accessible to the processor and configured to store instructions that, when executed, cause the processor to:
provide an interface to the computing device including an image of a location corresponding to an address and including one or more user-selectable elements accessible by a user to place one or more shape objects on the image;
receive data including pixel position data related to the one or more shape objects in response to providing the interface;
determine a cost estimate for a service to be performed based in part on the received data; and
provide the cost estimate to the computing device.

8. The computing device of claim 7, wherein the received data includes data related to an arrangement of shape objects overlaying the image, the arrangement determined by a user interacting with the one or more user-selectable elements.

9. The computing device of claim 7, wherein the received data includes data related to a number of stories of the structure, a steepness of the surface, and a complexity of the surface.

10. The computing device of claim 7, wherein the received data includes a type of replacement shingle parameter and a color parameter.

11. The computing device of claim 7, wherein the repair estimate includes a cost of removal of an existing surface, a cost of materials, a cost of labor, and other costs.

12. The computing device of claim 7, wherein the memory further includes instructions that, when executed, cause the processor to provide the interface with one or more user-selectable elements to prompt the user to provide the address, before providing the interface including the image of the structure.

13. The computing device of claim 12, wherein the memory further includes instructions that, when executed, cause the processor to retrieve the image of the structure from a data source based on the address.

14. The computing device of claim 13, wherein the image comprises a satellite image correlated to the address.

15. A computing device comprising:
a network interface configured to communicate with one or more computing devices through a network;
a processor; and
a memory accessible to the processor, the memory configured to store instructions that, when executed, cause the processor to:
receive an interface including an image associated with an address and including a user selectable element, the user-selectable element accessible by a user to place one or more shape objects on the image, each of the one or more shape objects accessible by the user to selectively reposition, resize, and rotate the shape object to cover a portion of the image;
send data related to pixel positions of the one or more shape objects to the server system; and
receive a cost estimate corresponding to real world dimensions corresponding to the portion of the image in response to sending the data.

16. The computing device of claim 15, wherein the computing device comprises at least one of a tablet computer, a laptop computer, and a smartphone.

17. The computing device of claim 15, further comprising a touchscreen interface coupled to the processor.

18. The computing device of claim 17, wherein the memory further includes instructions that, when executed, cause the processor to:
receive input data related to the shape object, the input data corresponding to at least one of a repositioning data parameter, a rotational data parameter, and a resizing data parameter; and
in response to receiving the input data, adjusting at least one of a position, an orientation, and a size of the shape object relative to the image.

19. The computing device of claim 17, further comprising providing the cost estimate to the touchscreen interface.

20. The computing device of claim 15, wherein the one or more shape objects overlap one another.
